(19) United States
(12) Patent Application Publication
(10) Pub. No.: US 2021/0157496 A1
(43) Pub. Date: May 27, 2021

(54) INFORMATION PROCESSING APPARATUS AND NON-TRANSITORY COMPUTER-READABLE RECORDING MEDIUM HAVING STORED THEREIN INFORMATION PROCESSING PROGRAM

(71) Applicant: FUJITSU LIMITED, Kawasaki-shi (JP)

(72) Inventors: Kazuichi Oe, Yokohama (JP); Satoshi Imamura, Kawasaki (JP); Eiji Yoshida, Yokohama (JP)

(73) Assignee: FUJITSU LIMITED, Kawasaki-shi (JP)

(21) Appl. No.: 17/061,604

(22) Filed: Oct. 2, 2020

(30) Foreign Application Priority Data
Nov. 21, 2019 (JP) 2019-210125

(51) Int. Cl. G06F 3/06; G06F 15/173

(52) U.S. Cl. CPC G06F 3/0635; G06F 3/0653; G06F 3/0659; G06F 15/17331; G06F 3/0673; G06F 3/067; G06F 3/0611

(57) ABSTRACT

An information processing apparatus includes: a memory region; a communication interface that is connected to an access apparatus different from the information processing apparatus; a storage region that the communication interface accesses in response to an access request from the access apparatus; and a processor coupled to the memory region and the storage region, and configured to access the memory region and the storage region, wherein the processor including a memory controller configured to control an access to the memory region and an access to the storage region, and the processor is configured to control, based on a state of one or more first accesses to the memory region and the storage region via the memory controller, a timing of executing a second access to the storage region that the communication interface makes via the memory controller.

### CROSS-REFERENCE TO RELATED APPLICATION

This application is based upon and claims the benefit of priority of the prior Japanese Patent application No. 2019-210125, filed on Nov. 21, 2019, the entire contents of which are incorporated herein by reference.

### FIELD

The embodiment discussed herein is related to an information processing apparatus and a non-transitory computer-readable recording medium having stored therein an information processing program.

### BACKGROUND

In an information processing apparatus such as a server or a Personal Computer (PC), an access to a main storage device exemplified by a memory, such as a Dynamic Random Access Memory (DRAM), is made by a processor (processing unit) such as a Central Processing Unit (CPU).

A processor includes one or more CPU cores (sometimes simply referred to as “cores”) and a memory controller. The core accesses data stored in the memory through execution of a process (may also be referred to as “program”), and the memory controller controls an access to the memory serving as an access target by the core.

In recent years, memories adopting the next generation memory technique have appeared. As such a memory, a memory adopting, for example, Intel Optane DC Persistent Memory (hereinafter, sometimes referred to as “PM”) (registered trademark) employing 3D XPoint (registered trademark) technique is known.

Compared with the DRAM, the PM has a lower process performance (particularly, a writing performance) (about one-tenth as an example), but are more inexpensive and larger in capacity (about ten-fold as an example).

Like the DRAM, the PM can be mounted on a memory slot, such as a Dual Inline Memory Module (DIMM) slot, and a memory controller controls accesses both to the DRAM and the PM. In other words, the DRAM, which is an example of a first memory, and the PM, which is an example of a second memory being different in process performance (process speed) from the DRAM coexist in the same storage (memory) layer.

In environment where the DRAM and the PM coexist in the same storage layer, an operation mode is prepared in which a program such as an application is arranged at least in a storing region (program region) of the DRAM and data is arranged at least in a part (storage region) of a storing region of the PM. In this operation mode, at least a part of the storing region of the PM can be used as storage.

[Patent Document 1] International Publication Pamphlet No. WO 2017/098591

[Patent Document 2] Japanese Laid-Open Patent Publication No. 2012-243117

[Patent Document 3] Japanese Laid-Open Patent Publication No. 2011-071764

The development of the PM assumes a usage that uses the PM included in an information processing apparatus (first information processing apparatus) as a shared storage region and causes another information processing apparatus (second information processing apparatus) to make a remote access to the shared storage region.

However, remote access to the storage region does not premise a case where the DRAM and the PM coexist in the same storage layer and the memory controller controls both the DRAM and the PM.

For example, it is assumed that an access to a program region (memory region) or a shared storage region made by an application executed by a processor (core) of an information processing apparatus and a remote access to the shared storage region are executed in parallel. In this case, there is a possibility that the processing time (processing delay) in a memory controller increases due to congestion caused from an access process by an application and a remote access processes, and memory accessing performance of the processor decreases.

### SUMMARY

According to an aspect of the embodiments, an information processing apparatus including: a memory region; a communication interface that is connected to an access apparatus different from the information processing apparatus; a storage region that the communication interface accesses in response to an access request from the access apparatus; and a processor coupled to the memory region and the storage region, and configured to access the memory region and the storage region, wherein the processor including a memory controller configured to control an access to the memory region and an access to the storage region, and the processor is configured to control, based on a state of one or more first accesses to the memory region and the storage region via the memory controller, a timing of executing a second access to the storage region that the communication interface makes via the memory controller.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a process speed and a storage capacity of each component provided in an information processing apparatus;

FIG. 2 is a block diagram schematically illustrating an example of the configuration of a server in which both DRAMs and PMs are mounted as memories;

FIG. 3 is a diagram illustrating a case in which a PC makes a remote access to a storage region of the server illustrated in FIG. 2;

FIG. 4 is a diagram illustrating an access process performed by a memory controller (MC);

FIG. 5 is a block diagram illustrating an example of a hardware (HW) configuration of a server according to one embodiment;

FIG. 6 is a block diagram schematically illustrating an example of a HW configuration focusing on processors and memories of a server according to one embodiment;

FIG. 7 is a block diagram schematically illustrating an example of a functional configuration of a server and a PC according to one embodiment;

FIG. 8 is a diagram illustrating operation of a server and a PC according to one embodiment;

FIG. 9 is a diagram illustrating an example of management information;

FIG. 10 is a diagram illustrating operation of a server and a PC according to one embodiment;

FIG. 11 is a diagram illustrating an example of storing a transfer request into a queue;

FIG. 12 is a diagram illustrating operation of a server and a PC according to one embodiment;

FIG. 13 is a diagram illustrating an example of a result of monitoring statistical information;

FIG. 14 is a diagram illustrating an example of a result of monitoring statistical information;

FIG. 15 is a flowchart illustrating an example of operation of an acquisition process of a region in a storage region performed by a server and a PC according to one embodiment; and

FIG. 16 is a flowchart illustrating an example of operation of control related to a Remote Direct Memory Access (RDMA) transfer performed by a server and a PC according to one embodiment.

### DESCRIPTION OF EMBODIMENT(S)

Hereinafter, an embodiment of the present invention will now be described with reference to the accompanying drawings. However, one embodiment described below is merely illustrative and there is no intention to exclude the application of various modifications and techniques not explicitly described below. For example, the present embodiment can be variously modified and implemented without departing from the scope thereof. In the drawings to be used in the following description, the same reference numbers denote the same or similar parts, unless otherwise specified.

### [1] Embodiment

### [1-1] Hybrid Memory System Using DRAMs and PMs

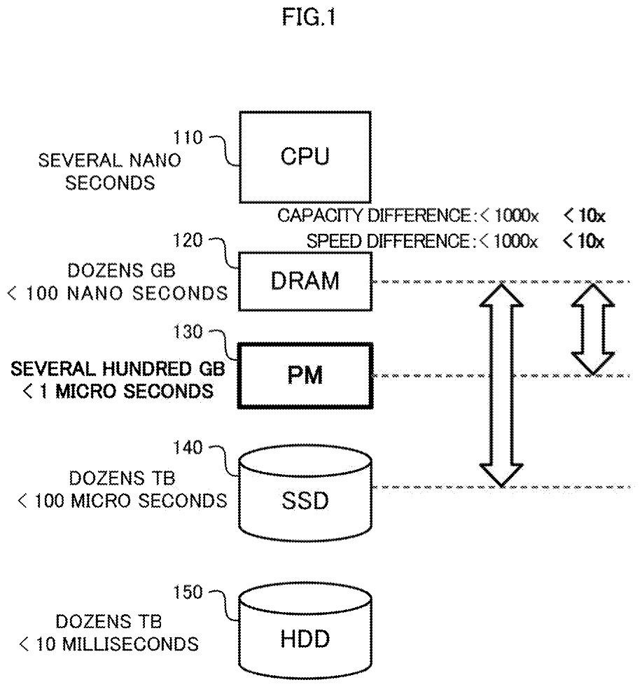

FIG. 1 is a diagram illustrating an example of process speeds (process performances) of components (modules) 110 to 150 provided in an information processing apparatus exemplified by a server and a PC and, if the component is a storage device, the storage capacity thereof.

As exemplarily illustrated in FIG. 1, aligning the components in the descending order of a process speed results in a CPU 110, a DRAM 120, a PM 130, a Solid State Drive (SSD) 140, and a Hard Disk Drive (HDD) 150. Aligning the components in the descending order of a storage capacity results in the HDD 150, the SSD 140, the PM 130, and the DRAM 120. Being compared with the SSD 140, the DRAM 120 has a process speed of about 1000 times, and a storage capacity of about 1/1000 times. The PM 130 is positioned between the DRAM 120 and the SSD 140 in terms of the process speed and the storage capacity, and when being compared with the PM 130, the DRAM 120 has a process speed of about ten times and a storage capacity of about one tenth.

This means that although being lower in process performance (particularly, writing performance) and lower in writing tolerance than the DRAM 120, the PM 130 is less expensive and larger in volume than DRAM 120. Similar to the DRAM 120, the PM 130 can be accessed in a unit of a byte and can be mounted on a memory slot such as a DIMM slot. Furthermore, since the PM 130 is non-volatile unlike the DRAM 120, the data in the PM 130 does not vanish when the power supply is cut off.

For these reasons, it is expected that an information processing apparatus mounting thereon both the DRAM 120 and the PM 130 as memory (main storage device) will become popular.

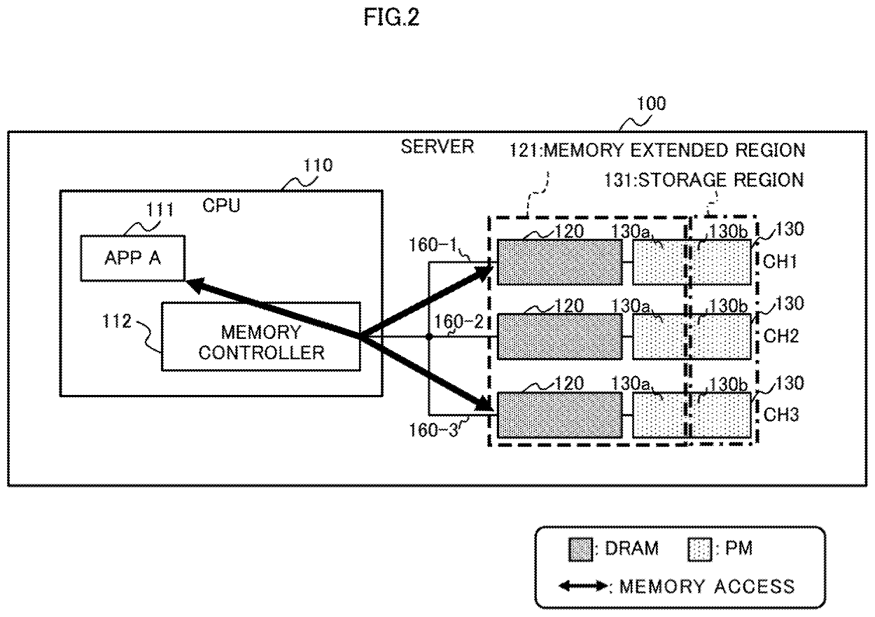

FIG. 2 is a block diagram schematically illustrating an example of a configuration of a server 100, serving as an example of an information processing apparatus, in which both DRAMs 120 and PMs 130 are mounted as memories.

As illustrated in FIG. 2, the server 100 is illustratively provided with the CPU 110, multiple DRAMs 120, and multiple PMs 130. The server 100 constitutes a hybrid memory system by using the DRAMs 120 and the PMs 130. In the hybrid memory system, the DRAM 120 serving as an example of a first memory and the PM 130 serving as an example of a second memory different in process performance (process speed) from the DRAM 120 coexist in the same storage (memory) layer.

As illustrated in FIG. 2, in the server 100, the DRAM 120 and the PM 130 cascaded by a memory channel 160-1 constitute a channel (CH) 1. Similarly, the DRAM 120 and the PM 130 which are cascaded by a memory channel 160-2 constitute a CH2, and the DRAM 120 and the PM 130 which are cascaded by a memory channel 160-3 constitute a CH3.

The server 100 may also include a memory extended region 121 formed by extending storing regions of the multiple DRAMs 120. The memory extended region 121 is a region formed by extending the storing regions of the multiple DRAMs 120 using at least some of storing regions 130a among the multiple PMs 130, and may be mainly used for storing a program such as an application.

The server 100 may further include a storage region 131. The storage region 131 is a region using at least some of storing regions 130b of the multiple PMs 130, and may be mainly used for storing data (e.g., user data). The storage region 131 is allowed to be remotely accessed by other information processing apparatus different from the server 100 and may be referred to as a “shared” storage region 131 shared with the other information processing apparatus.

Here, the storing regions 130a and 130b may have an exclusive relationship with each other, for example, the sum of the size of the storing region 130a and the size of the storing region 130b may be equal to the total sum of the sizes of the storing regions of the PMs 130. Also, the size of the storing region 130a may be zero. That is, the size of the memory extended region 121 may be equal to the total sum of the sizes of the multiple DRAMs 120, and the size of the storage region 131 may be equal to the sum of the sizes of the multiple PMs 130.

The CPU 110 includes a core (no: illustrated) and a memory controller 112, and an application 111 (denoted as “APP A” in FIG. 2) arranged in the memory extended region 121 is executed by the core. The APP A accesses the memory extended region 121 or the storage region 131 under control of the memory controller 112. For example, the memory controller 112 reads a program code of the APP A from and writes control information into the memory extended region 121, and reads and writes data to be used by the APP A from and into the storage region 131.

With this configuration, the APP A can access each of the DRAMs 120 and the PMs 130 without delay in the server 100.

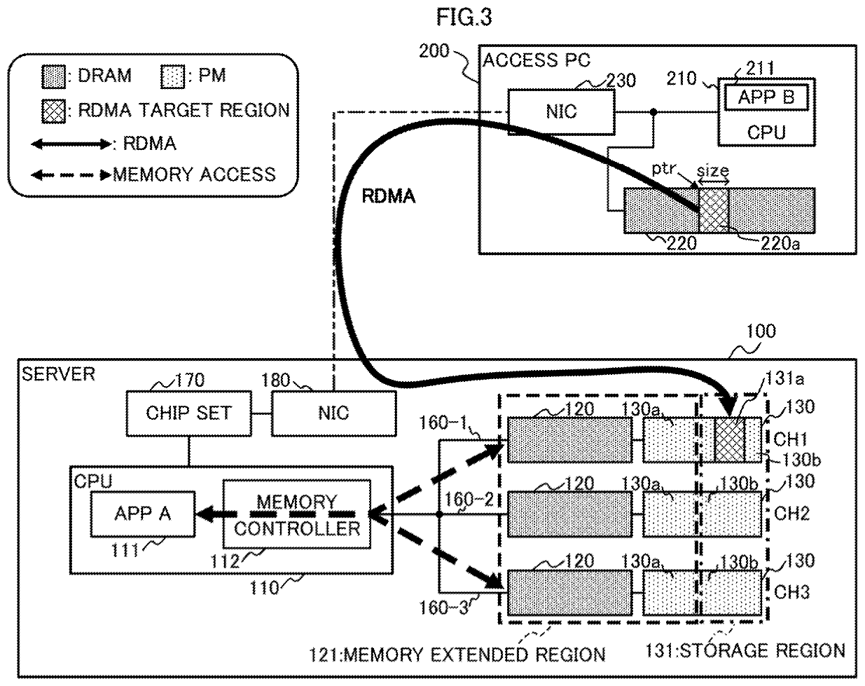

FIG. 3 is a diagram illustrating a case where a PC 200 serving as an example of another information processing apparatus makes a remote access to the storage region 131 of the server 100 illustrated in FIG. 2.

Hereafter, an example of a remote access is assumed to be a Remote Direct Memory Access (RDMA). The term DMA is a method of transferring data directly between memories (or between a memory and an Input/Output (I/O) device). The RDMA is a scheme of DMA-transferring data over a network from a memory of a first computer to a memory of a second computer.

The PC 200 is an access PC that accesses the storage region 131 of the PM 130. The PC 200 may be, for example, a controller (e.g., a controller module (CM)) of a storage apparatus. As illustrated in FIG. 3, the PC 200 illustratively includes a CPU 210 that performs an application 211 (denoted as “APP B” in FIG. 3), a DRAM 220, and a Network Interface Controller (NIC) 230.

The NIC 230 sends, to the server 100, a request including a pointer specifying the starting position of a transfer target region 220a in the DRAM 220 and a transfer sizes of the transfer target region 220a (referred to as “ptr” and “size” in FIG. 3).

The server 100 includes a chip set 170 and an NIC 180 in addition to the elements illustrated in FIG. 2. The NIC 180 reads data having a “size” at a position starting at “ptr” position of the DRAM 220 of the PC 200 in response to the request received from the NIC 230. Then, the NIC 180 controls writing of the read data into a write target region 131a of a storage region 131 via the chip set 170 and the memory controller 112.

This cooperation of the NICs 230 and 180 achieves RDMA transfer of data from the DRAM 220 of the PC 200 to the shared storage region 131 of the server 100.

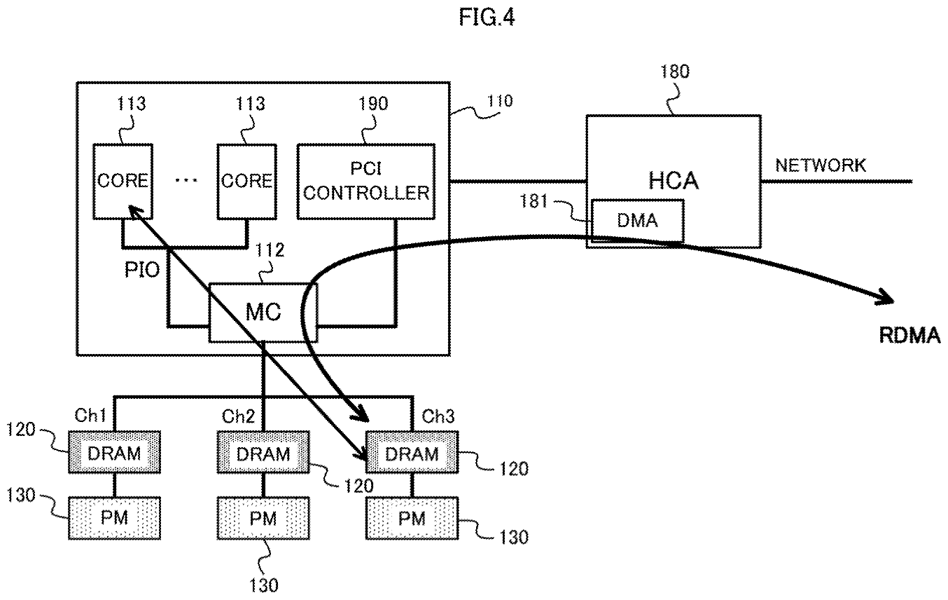

FIG. 4 is a diagram illustrating an access process performed by the memory controller (denoted as “MC” in FIG. 4) 112.

The example of FIG. 4 assumes that the NIC 180 (and the NIC 230) is a Host Channel Adapter (HCA) compatible with the standard of InfiniBand (registered trademark). In this instance, the server 100 and the PC 200 may be connected to each other via a network connecting the NIC 180 to the NIC 230 in a switched fabric fashion. The HCA 180 may also include a DMA controller 181 that controls the RDMA.

Furthermore, in the example of FIG. 4, the CPU 110 is assumed to include a Peripheral Component Interconnect (PCI) controller 190 as a part of the function of the chip set 170.

As illustrated in FIG. 4, Programmed I/Os (PIOs) for the DRAM 120 or the PM 130 issued from the multiple cores 113 of the CPU 110, and a writing access to the PM 130 by the RDMA pass through the MC 112.

As a result, a delay on the PIO side increases as writing into the PC 130 by the RDMA increases. This is because the DMA controller 181 of the HCA 180 starts the RDMA regardless of a state of accesses in the DRAMs 120 and/or the PMs 130. Furthermore, as described above, since the PM 130 has lower processing performance, particularly lower writing performance (e.g., about one-tenth) than the DRAM 120, the delay on the PIO side remarkably increases.

Thus, in cases where an access to the memory extended region 121 or the storage region 131 by the APP A and an access to the storage region 131 by the RDMA are executed in parallel, congestion of the processes may occur in the MC 112. In this case, there is a possibility that the processing time (processing delay) in the MC 112 increases and the memory accessing performance of the CPU 110 decreases. This may accompany an increase of the response delay to the PC 200.

Accordingly, for the DRAM 120 and the PM 130 whose accesses are controlled by the same MC 112, a demand arises for a method of controlling an access from the application 111 and a remote access so as not to generate congestion is desired.

Therefore, in one embodiment, description will now be made in relation to a method of accessing the storage region 131 of the PM 130 without impairing the memory accessing performance from the application.

### [1-2] Example of Hardware Configuration of One Embodiment

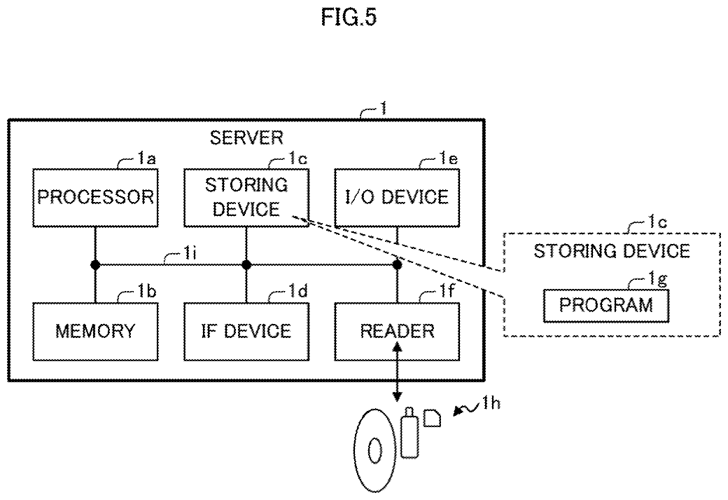

FIG. 5 is a block diagram illustrating an example of a HW configuration of a server 1 according to one embodiment. The server 1 is an example of the information processing apparatus. As the information processing apparatus, the server may be substituted with various computers such as a PC, a mainframe, and the like. The server 1 may include, by way of example, a processor 1a, a memory 1b, a storing device 1c, an IF (Interface) device 1d, an I/O (Input/Output) device 1e, and a reader 1f as the HW configuration.

The processor 1a is an example of an arithmetic processing apparatus that performs various controls and arithmetic operations. The processor 1a may be communicably connected to the blocks in the server 1 to each other via a bus 1i. In one embodiment, the processor 1a may be a multiprocessor including multiple processors (e.g., multiple CPUs). Also, each of the multiple processors may be a multi-core processor having multiple processor cores.

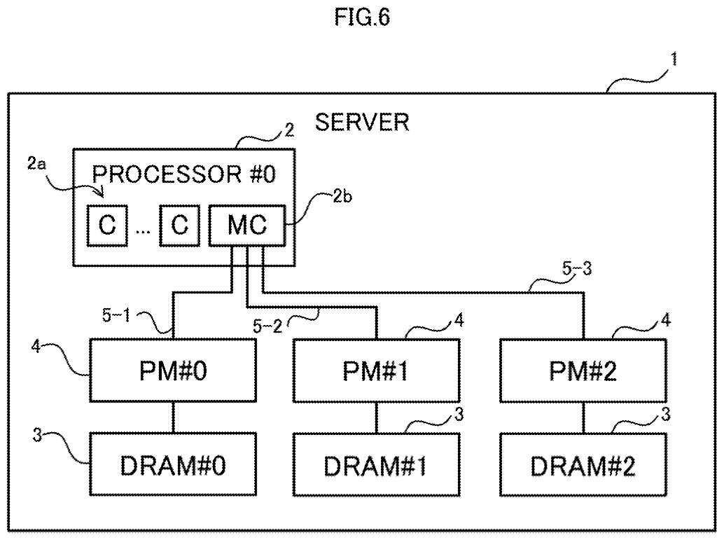

FIG. 6 is a block diagram schematically illustrating an example of the HW configuration focusing on the processor 1a and the memory 1b of the server 1 according to one embodiment. As exemplarily illustrated in FIG. 6, the processor 1a illustrated in FIG. 5 may be one or more (one in the example of FIG. 6) processors 2. The processor 2 may include multiple cores (represented by “C”) 2a and an MC 2b.

The MC 2b is connected to one or more (three in the example of FIG. 6) DRAMs 3 and one or more (three in the example of FIG. 6) PMs 4 via a memory channel 5 to manage both the DRAMs 3 and the PMs 4. For example, the MC 2b is cascaded to a set of the DRAM #0 and the PM #0 via a memory channel 5-1. Likewise, the MC 2b is cascaded to a set of the DRAM #1 and the PM #1 via a memory channel 5-2; and the MC 2b is cascaded to a set of the DRAM #2 and the PM #2 via a memory channel 5-3.

For example, the MC 2b may associate different address ranges one with each the DRAM 3 and the PM 4 of each memory channel 5. The MC 2b may alternatively access one of the DRAM 3 or the PM 4 via the memory channel 5 shared by the DRAM 3 and the PM 4 with reference to a memory address specified from the core 2a. In other words, the MC 2b may control accesses to the DRAM 3 and the PM 4.

As the processor 1a, the CPU may be replaced with an Integrated Circuit (IC) such as a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA).

Referring back to the description of FIG. 5, the memory 1b is an example of a HW device that stores information such as various data and programs. Examples of the memory 1b include, for example, both a volatile memory such as the DRAM, and a non-volatile memory such as the PM. This means that, the server 1 according to one embodiment may achieve the hybrid memory system that uses the DRAM 3 and the PM 4.

Note that the DRAM 3 is an example of the first memory, and the PM 4 is an example of the second memory that differs (e.g., is slow) in process speed from the first memory and that shares at least a part of a storing region with the first memory.

The storing device 1c is an example of a HW device that stores information such as various data and programs. Examples of the storing device 1c include, for example, various storage device such as a semiconductor drive device such as a Solid State Drive (SSD), a magnetic disk device such as a Hard Disk Drive (HDD), a non-volatile memory. Examples of the non-volatile memory include, for example, a flash memory, a Storage Class Memory (SCM), and a Read Only Memory (ROM).

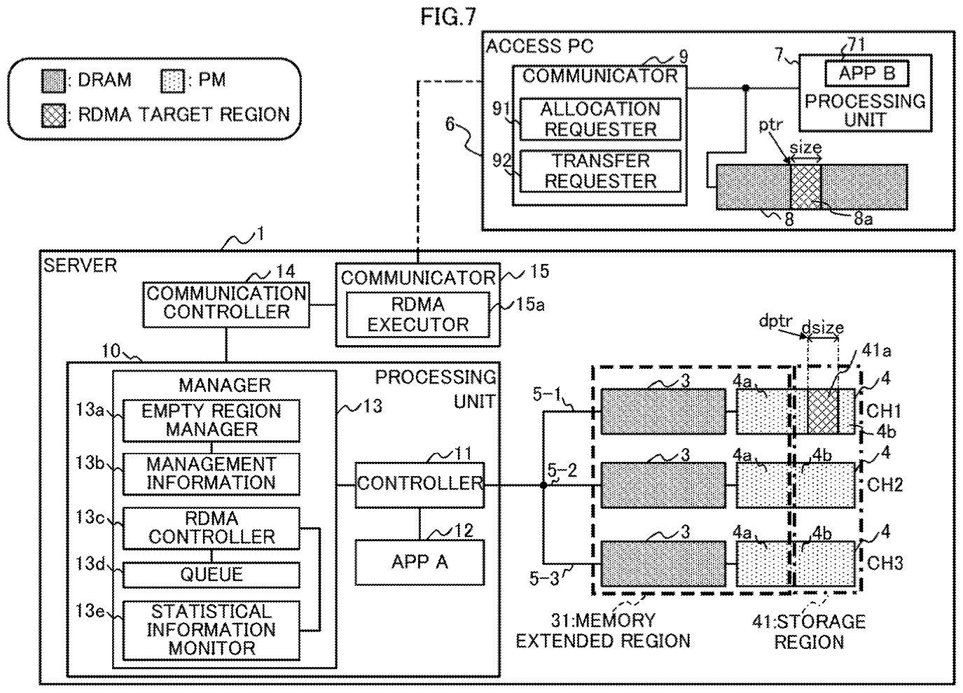

The storing device 1c may also store a program 1g that implements all or some of the various functions of the server 1. For example, the processor 1a of the server 1 can achieve the function as a processing unit 10 to be described below and illustrated in FIG. 7 by expanding the program 1g (information processing program) stored in the storing device 1c onto the memory 1b and executing the expanded program 1g.

The IF device 1d is an example of a communication IF that controls the connection to and communication with a non-illustrated network. For example, the IF device 1d may include an adapter conforming to a Local Area Network (LAN) such as InfiniBand (registered trademark) and Ethernet (registered trademark), optical communication (e.g., Fibre Channel (FC)), or the like. For example, the program 1g may be downloaded from a network to the server 1 via the communication IF and stored into storing device 1c.

The I/O device 1e may include one or both of an input device, such as a mouse, a keyboard, or an operating button, and an output device, such as a touch panel display, a monitor, such as a Liquid Crystal Display (LCD), a projector, or a printer.

The reader 1f is an example of a reader that reads information of data and programs recorded on a recording medium 1h. The reader 1f may include a connecting terminal or device to which the recording medium 1h can be connected or inserted. Examples of the reader 1f include an adapter conforming to, for example, a Universal Serial Bus (USB), a drive apparatus that accesses a recording disk, and a card reader that accesses a flash memory such as an SD card. The program 1g may be stored in the recording medium 1h. The reader 1f may read the program 1g from recording medium 1h and store the read program 1g into the storing device 1c.

The recording medium 1h is example of a non-transitory recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the server 1 described above is merely illustrative. Accordingly, the server 1 may appropriately undergo increase or decrease of HW (e.g., addition or deletion of arbitrary blocks), division, integration in an arbitrary combination, and addition or deletion of the bus.

Further, a PC 6 serving as an exemplary information processing apparatus, which will be described below with reference to FIG. 7, may have the same HW configuration as that of the server 1. For example, a processor 1a of the PC 6 can achieve the function as the PC 6 by expanding a program 1g stored in a storing device 1c onto a memory 1b and executing the expanded program 1g.

### [1-3] Example of Functional Configuration of One Embodiment

FIG. 7 is a block diagram illustrating an example of the functional configuration of the server 1 and the PC 6 according to one embodiment. As illustrated in FIG. 7, the server 1 may illustratively include a processing unit 10, a DRAM 3, a PM 4, a communication controller 14, and a communicator 15, focusing on the functions for access control according to one embodiment.

The processing unit 10 executes various processes in the server 1, and is an example of the function achieved by the processor 2 illustrated in FIG. 6. The DRAM 3 and the PM 4 are similar to the DRAM 120 and the PM 130 illustrated in FIG. 2, respectively.

The DRAM 3 and the PM 4 constitute a memory extended region (program region) 31, which is an example of a memory region accessed by the processing unit 10, by the storing region of the DRAM 3 and at least a part of the storing region of the PM 4.

The PM 4 also constitutes a storage region 41 that the communicator 15 accesses in response to RDMA transfer requests from the processing unit 10 and the PC 6, by at least a part of the storing region of the PM 4. The storage region 41 may be accessibly shared from information processing apparatuses, such as the PC 6, and may be referred to as a shared storage region 41.

The communication controller 14 controls communication between the components in the server 1 and is an example of the chip set 170 illustrated in FIG. 2.

The communicator 15 communicates with the PC 6 and is an example of the communication interface connected to the PC 6. The communicator 15, in one embodiment, may include an IF conforming to the standard of Infiniband (registered trademark). The communicator 15 is an example of the function achieved by the IF device 1d being illustrated in FIG. 5 and being exemplified by the HCA, which is an NIC compatible with Infiniband.

The communicator 15 may include an RDMA executor 15a that performs an RDMA, as illustrated in FIG. 7.

The RDMA executor 15a executes an RDMA transfer to the storage region 41 specified in an instruction from an RDMA controller 13c of a manager 13 to be described below in response to the instruction.

The PC 6 is an access PC that accesses the storage region 41 in the server 1, and is an example of an access device being different from the server 1. As illustrated in FIG. 7, the PC 6 may illustratively include a processing unit 7, a DRAM 8, and a communicator 9, focusing on a function for access control according to one embodiment.

The processing unit 7 executes various processes in the PC 6 and is an example of the function achieved by the processor 2 illustrated in FIG. 6. The DRAM 8 is similar to the DRAM 220 illustrated in FIG. 3. The communicator 9 communicates with the server 1 and, in one embodiment, includes an IF that conforms to the standard of Infiniband.

The communicator 9 is an example of the function achieved by the IF device 1d, e.g., the HCA, illustrated in FIG. 5. As illustrated in FIG. 7, the communicator 9 may include an allocation requester 91 and a transfer requester 92.

Before sending an RDMA transfer request, the allocation requester 91 transmits an acquisition request of a region 41a in the storage region 41, serving as the target of the RDMA transfer, to the server 1. The acquisition request may include information about the size (denoted as “size”) of data to be transferred from the DRAM 8 to the storage region 41 through the RDMA transfer.

When receiving an acquisition response responsive to the acquisition request from the server 1, the allocation requester 91 outputs the information of the region 41a in the acquired storage region 41 included in the acquisition response to the transfer requester 92. The information of the region 41a may include pointers and sizes (referred to as “dptr” and “dsize”, respectively) of the acquired region 41a. The pointer (dptr) may be a leading memory pointer indicating a physical storage position of the region 41a.

The transfer requester 92 transmits an RDMA transfer request, including a pointer and a size (“ptr” and “size”) of a region 8a, and the pointer and the size (“dptr” and “dsize”) of the region 41a obtained by the allocation requester 91 to the server 1. The pointer (ptr) of the region 8a is an example of information indicating a physical address (or logical address) of the DRAM 8 of the transfer source (access source) of the RDMA transfer request. The pointer (dptr) of the region 41a is an example of information that specifies the position of the acquired region 41a in the storage region 41 of the transfer destination (access destination) of the RDMA transfer request.

When receiving a completion response (e.g., ACK) of the RDMA transfer from the server 1, the transfer requester 92 may transmit a completion response to the request source of the RDMA.

### [1-3-1] Example of Functional Configuration of Processing Unit of Server

As illustrated in FIG. 7, the processing unit 10 of the server 1 may illustratively include the functions of a controller 11, an application 12 (denoted as “APP A”), and the manager 13. The controller 11 is an example of the function achieved by the MC 2b of the processor 2 exemplarily illustrated in FIG. 6. The application 12 and the manager 13 may be achieved by the core 2a of the processor 2 exemplarily illustrated in FIG. 6 executing the program 1g expanded in the memory extended region 31. Alternatively, the manager 13 may be a part of the function of an operating system (OS) that the core 2a executes.

The controller 11 controls access from the application 12 to the memory extended region 31 or to the storage region 41, and also controls access from the PC 6 to the storage region 41 via the manager 13.

Similar to the application 111 illustrated in FIG. 2, the application 12 accesses the memory extended region 31 or the storage region 41 via the controller 11.

The manager 13 is a storage manager that manages the storage region 41 and controls a timing of executing an RDMA from the PC 6 to the server 1 so as to abate congestion of access processes by the controller 11.

As illustrated in FIG. 7, the manager 13 may illustratively include an empty region manager 13a, a management information 13b, an RDMA controller 13c, a queue 13d, and a statistical information monitor 13e. The management information 13b and information of the queue 13d may be stored in, for example, the memory extended region 31.

The empty region manager 13a manages the empty storing region in the storage region 41. For example, when receiving an acquisition request transmitted from the allocation requester 91 of the PC 6 before the RDMA transfer, the empty region manager 13a reserves the region 41a in the storage region 41 serving as the target of the RDMA transfer on the basis of the acquisition request. An example of the region 41a may be an empty region. The empty region may be, for example, an unused (unallocated) region that has not been allocated with a logical address.

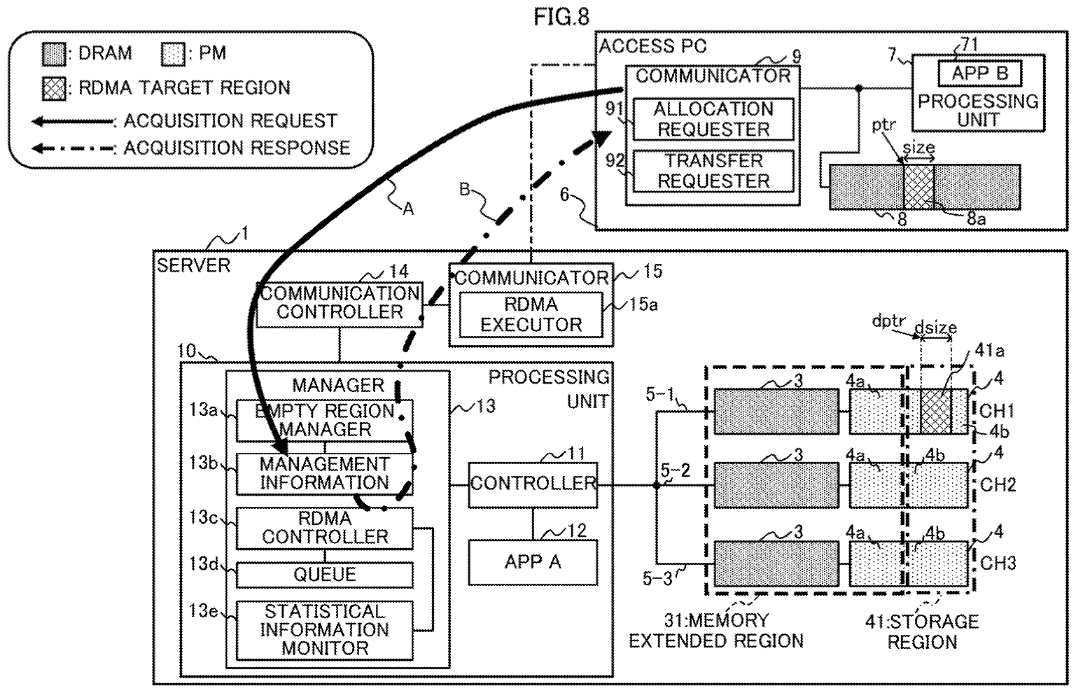

By way of example, upon receiving an acquisition request from the allocation requester 91 via the communicator 15 and the communication controller 14 as indicated by the arrow A in FIG. 8, the empty region manager 13a may acquire the region 41a of the size from the storage region 41. In other words, the empty region manager 13a may allocate the region 41a to the RDMA transfer of the PC 6 based on the acquisition request.

For example, the empty region manager 13a registers the size of the region 8a included in the acquisition request and the pointer and the size (denoted as “dptr” and “dsize”, respectively) of a physical address of the acquired region 41a into the management information 13b.

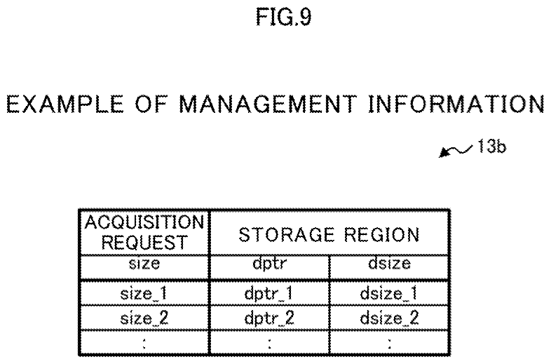

FIG. 9 is a diagram illustrating an example of the management information 13b. In FIG. 9, the management information 13b takes a table format for convenience, but the format is not limited to this. Alternatively, the management information 13b may be stored in the memory extended region 31 in various formats such as a Database (DB) or an array.

As illustrated in FIG. 9, the management information 13b may include, as specified by an acquisition request, “size” indicating the data size of the RDMA transfer and items of “dptr” and “dsize” indicating the target region of the RDMA transfer on the storage region 41 side.

In cases where information (for example, an ID (Identifier) included in a command) that can specify the command of the RDMA transfer and that is transmitted from the PC 6 after acquisition request or the like is present, the information may be registered in management information 13b in place of “size”. In addition, in cases of “size”=“dsize”, the item of “dsize” may be omitted.

Also, information of “dptr” and “dsize” is transmitted to the allocation requester 91 after acquisition by the empty region manager 13a, and then a transfer request including the information of “dptr” and “dsize” is transmitted from the transfer requester 92 to the manager 13. Therefore, the manager 13 does not have to retain the information of “dptr” and “dsize” after the acquisition. In other words, the configuration of the management information 13b may be omitted from the server 1.

The empty region manager 13a, as indicated by the arrow B in FIG. 8, transmits an acquisition response with respect to the acquisition request, including the information of the acquired region 41a, to the PC 6 via the communication controller 14 and the communicator 15. The acquisition response may include, for example, at least the information of the pointer (dptr) of the region 41a, and may further include the information of the size (dsize) of the acquired region 41a.

As described above, the empty region manager 13a is an example of an acquisition unit that, upon receipt of the acquisition request for the storage region 41 from the PC 6, reserves a region 41a having a size assigned by the acquisition request in the storage region 41, and transmits the acquisition response including information that specifies a position of the reserved region 41a to the PC 6.

The RDMA controller 13c controls, based on the access state of a memory access by the controller 11, the timing of executing the RDMA transfer based on the RDMA transfer request (transfer request) received from the PC 6.

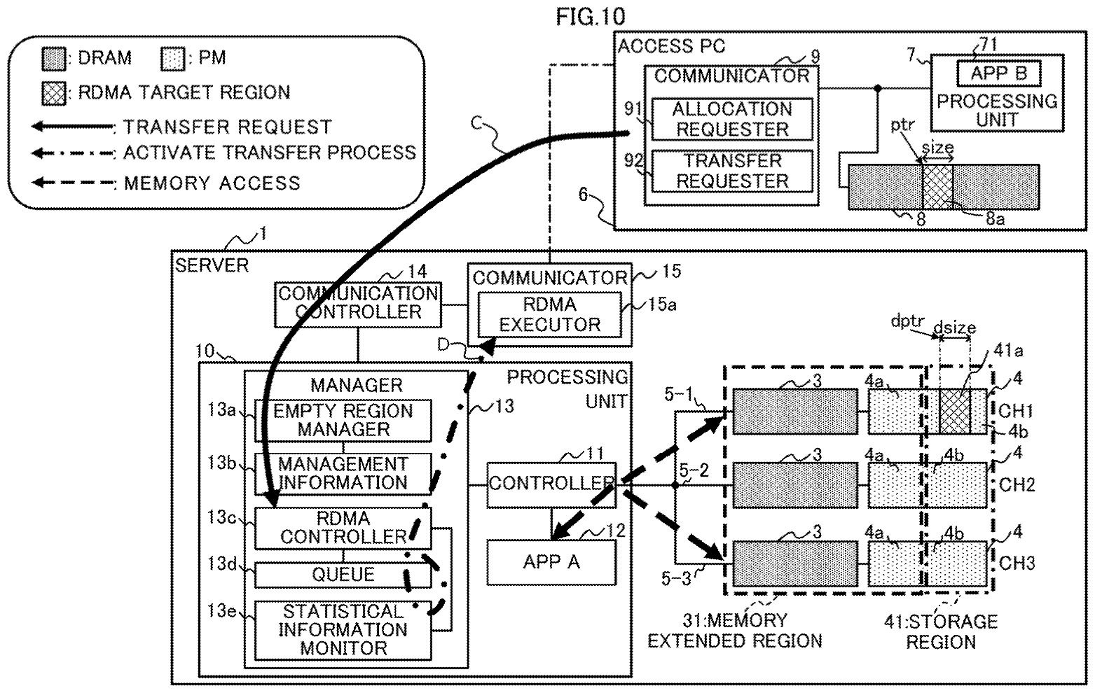

For example, when receiving the RDMA transfer request (transfer request) from the transfer requester 92 of the PC 6 via the communicator 15 and the communication controller 14, the RDMA controller 13c inserts (stores) the received transfer request into the queue 13d as indicated by the arrow C in FIG. 10.

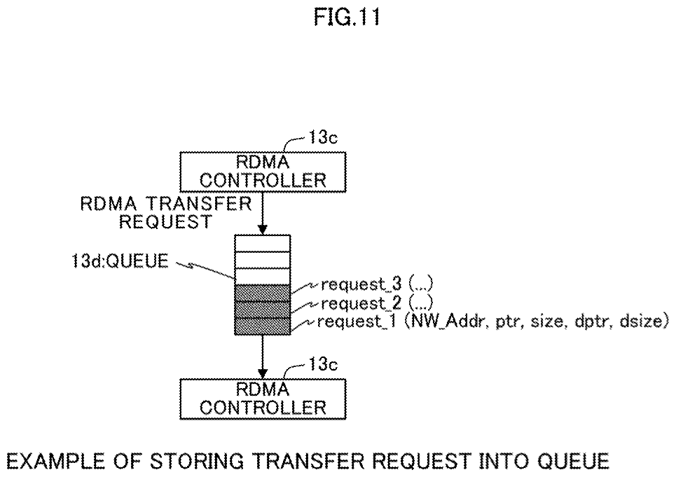

FIG. 11 is a diagram illustrating an example of storing at a transfer request into the queue 13d. As illustrated in FIG. 11, the queue 13d may be a storing region having the First-In First-Out (FIFO) structure. The RDMA controller 13c may store the received transfer request, e.g., an RDMA write request or an RDMA read request, in order of reception into the queue 13d. An RDMA transfer request may illustratively include NW_Addr, ptr, size, dptr, and dsize. NW_Addr is the NW address of the request source, and may be, for example, the address of the HCA which is an example of the communicator 9. The address of the HCA may be, for example, a port number.

In addition, the RDMA controller 13c obtains an access count of memory accesses made by the controller 11 during each regular time interval T by referring to the statistical information monitor 13e, and waits for the timing when accesses to the DRAM 3 and the PM 4 are few based on the access counts. The access counts may be, for example, the number of access requests processed by the controller 11, and is an example of the statistical information to be used to analyze the access state of memory accesses.

The statistical information monitor 13e monitors the number (access count) of memory accesses (see the dashed arrow in FIG. 10) to the memory extended region 31 and the storage region 41 to be processed by the controller 11 (e.g., MC 2b). For example, the statistical information monitor 13e may count access counts using a counter that counts access processes to the memory extended region 31 and the storage region 41 executed by the controller 11. The statistical information monitor 13e may include a storing region, such as a register, that stores a counted access counts as a result of monitoring.

The access counts serving as a result of monitoring may be reset (initialized) at regular time intervals T. Incidentally, T may be a time interval of about 1 millisecond, for example.

As illustrated by the arrow D in FIG. 10, when detecting the access count is small through monitoring the statistical information monitor 13e, the RDMA controller 13c determines that the detected timing is the timing of executing the RDMA transfer. Then the RDMA controller 13c controls execution of the RDMA transfer related to the transfer request stored and suspended in the queue 13d.

For example, when the timing of executing comes, the RDMA controller 13c may read the transfer request stored at the leading position in the queue 13d and notify the RDMA executor 15a in the communicator 15 of the contents of the transfer request via the communication controller 14. For example, the RDMA controller 13c may start an RDMA transfer process that the RDMA executor 15a performs by writing the contents of the transfer request in a non-illustrated memory in the RDMA executor 15a.

The transfer request stored at =he leading position in the queue 13d is the transfer request stored the most previously into the queue 13d, and is the transfer request of “request_1” in FIG. 11.

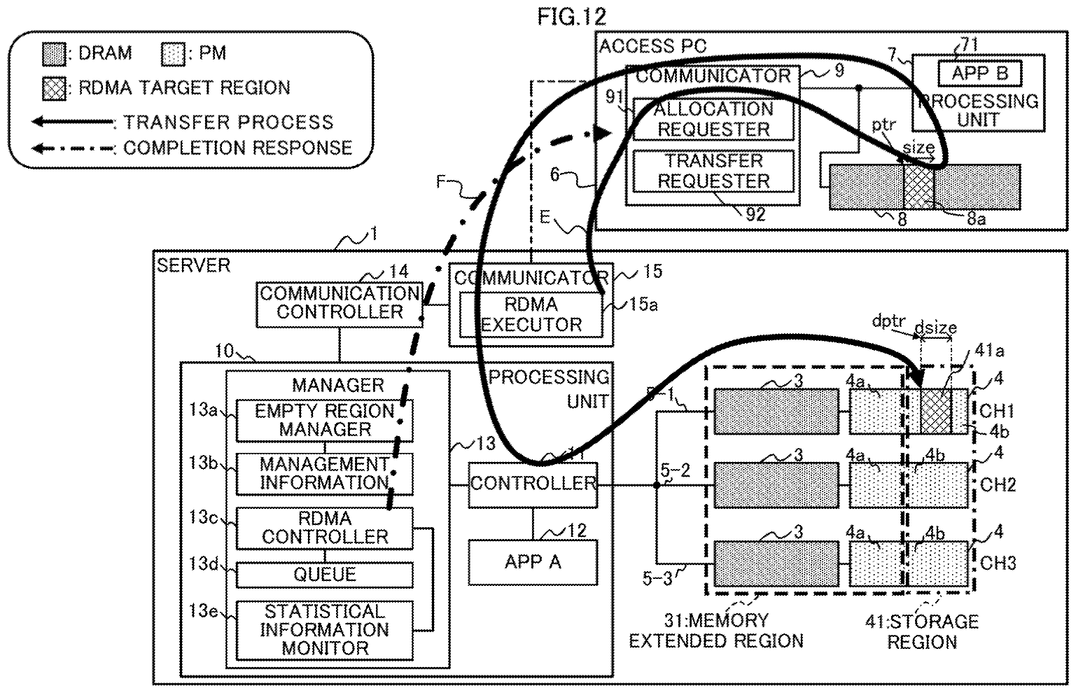

As indicated by the arrow E in FIG. 12, when being notified of the contents of the transfer request from the RDMA controller 13c (for example, when the request is written into the memory), the RDMA executor 15a carries out the RDMA transfer process in response to the transfer request.

For example, in cases where the request is an RDMA write request, the RDMA executor 15a reads data as much as the “size” from the region 8a in the DRAM 8 specified by the “ptr” via the communicator 9 of the PC 6 and the MC 2b. Then, the RDMA executor 15a writes the read data of “dsize” into the region 41a in storage region 41 specified by the “dptr” via the communication controller 14 and the controller 11 (e.g., the MC 2b). Incidentally, such an RDMA transfer process by the RDMA executor 15a may be performed in a scheme defined in a standard, such as Infiniband, that the RDMA is compliant.

Further, as indicated by the arrow F in FIG. 12, upon detecting the completion of the RDMA transfer process, the RDMA controller 13c may transmit a completion response (ACK) of the transfer request to the PC 6 (the transfer requester 92) that is the sender of the transfer request via the communication controller 14 and the communicator 15. The completion of the RDMA transfer process may be detected, for example, by the RDMA controller 13c monitoring communication or operation of the RDMA executor 15a, or by notifying the RDMA controller 13c of the completion of the RDMA transfer from the RDMA executor 15a.

Further, the RDMA controller 13c may remove the transfer request having been the target of the executing from the queue 13d after notifying the transfer request to the RDMA executor 15a or transmitting the completion response to the PC 6.

As described above, the RDMA controller 13c is an example of an access controller that controls, based on a state of one or more first accesses to the memory extended region 31 and the storage region 41 through the controller 11 made by the processing unit 10, a timing of executing a second access. The second access is an access to the storage region 41 through the controller 11 made by the communicator 15.

As described above, the server 1 of one embodiment, based on the state of the first accesses, controls the execution of the RDMA transfer at a timing when, for example, the access count is detected to be small. In other words, the RDMA controller 13c suspends an RDMA transfer request from the access PC 6 while the access count to the DRAM 3 and the PM 4 is large.

Thereby, the server 1 can achieve control such that the access from the APP A to the DRAM 3 and the PM 4 belonging to the same storage layer and the RDMA transfer from the PC 6 are avoided from congestion. Accordingly, the server 1 can execute the RDMA transfer to the storage region 41 without impairing the memory accessing performance from the APP A by controlling the timing of executing the RDMA transfer on the basis of the access state to the memory.

Further, the PC 6 can recognize (detect) the completion of the RDMA transfer by notification from the RDMA controller 13c. Accordingly, the PC 6 can eliminate the requirement to execute processes of issuing an inquiry as to whether the RDMA transfer is completed to the server 1 and providing an ample time to the standby time from the transfer request to the completion, so that consumption of communication and process resources of the PC 6 can be reduced.

### [1-3-2] Examples of Detecting Access Count to be Small

Hereinafter, description will now be made in relation to an exemplary method of detecting that the access count is small through monitoring the statistical information monitor 13e by the RDMA controller 13c, in other words, determining the timing of executing the RDMA transfer.

For example, when the state of the one or more first accesses made by the processing unit 10 satisfies a condition for suppressing access congestion in the controller 11, the access congestion being caused by execution of the one or more first accesses and the second access, the RDMA controller 13c may cause the communicator 15 to execute the second access. The conditions for suppressing access congestion may be ones below.

When the transfer request is stored in the queue 13d, the RDMA controller 13c reads the access counts of the statistical information monitor 13e from the statistical information monitor 13e at regular time intervals T and resets the access counts of the statistical information monitor 13e after the reading.

The RDMA controller 13c stores M access counts in a memory, e.g., in the memory extended region 31, with numbering the access count collected immediately before to CNT[0] and the access count collected the one previous time to CNT[−1], . . . , CNT[−(M−1)] at regular time intervals T. Incidentally, M is, for example, an integer of about 2 to several tens, and is 10 as an example.

For example, the RDMA controller 13c may add the latest access count CNT[0] the most recently acquired to the memory extended region 31 by updating the access counts stored in the memory extended region 31 in the following order (i) to (iii) at regular time intervals T.

(i) delete the oldest CNT[−(M−1)].

(ii) update CNT[0] to CNT[−(M−2)] to CNT[−1] to CNT[−(M−1)], respectively.

(iii) store the acquired access count as CNT[0].

Then, the RDMA controller 13c, when the access counts are below a predetermined threshold E, detects that the access count is small, in other words, determines that the timing of executing the RDMA transfer comes. The threshold E is a criterion access count with which an access count can be determined to be small, and may be set on the basis of conditions such as the type of application 12, the tendency of access, the processing performance of the MC 2b, and the like.

The determination of whether the access counts are below the threshold E may be made, for example, in accordance with one or both of the following logics (a) and (b).

### (a) First Logic

For example, the RDMA controller 13c extracts the immediately preceding M access counts from the memory extended region 31 and calculates the number K of access counts below the threshold E (for convenience, denoted as “threshold E1”) among the M access counts.

The RDMA controller 13c may store the result of determining whether or not the access counts are below the threshold E1 in association with the CNT[0] to CNT[−(M−1)] stored in the memory extended region 31. In this case, the RDMA controller 13c may determine, in the determination for each regular time interval T, whether or not the latest CNT[0] is below the threshold E1, and may read the result of determining whether or not CNT[−1] to CNT[−(M−1)] are below the threshold E1.

When the calculated number K is a threshold L of the number or more, the RDMA controller 13c determines that the access count is small. The threshold L of the number, for example, may be determined according to the value of M, and may be set to a value of M or less, as an example.

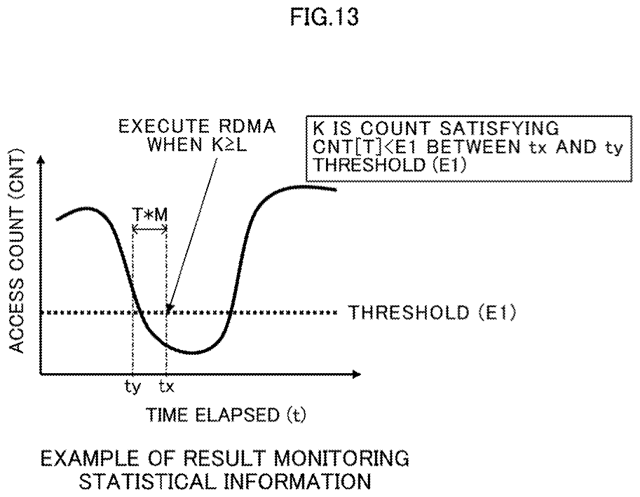

FIG. 13 is a diagram illustrating an example of a result of monitoring the statistical information. As illustrated in FIG. 13, the RDMA controller 13c makes a threshold determination at predetermined time intervals T along the first logic.

For example, at the time tx, the RDMA controller 13c determines that the number K of access counts below the threshold E1 among the latest M access counts in the T×M period (ty to tx) is equal to or greater than the threshold L. On the basis of this determination, the RDMA controller 13c reads the transfer request from the queue 13d and notifies the RDMA executor 15a of the contents of the transfer request.

Thus, the RDMA controller 13c may detect that, in cases where determining the number K of access counts below the threshold E1 to be the threshold L or more, the access count is small, in other words, may determine that the timing of executing the RDMA transfer comes.

That is, the condition for suppressing the access congestion is satisfied when, among M access counts obtained by the RDMA controller 13c at regular time intervals T, L or more access counts are below the threshold E1.

Incidentally, the threshold L of the number may be the same value as M. In this case, the condition for determining that the access count is small is that the access count is below the threshold E (threshold E1) and M (=L) consecutive times, in other words, that the access counts of the latest M (=L) times are all below the threshold E (threshold E1).

In this case, the condition for suppressing the access congestion is satisfied when M access counts obtained by the RDMA controller 13c at regular time intervals T are all below the threshold.

### (b) Second Logic

For example, the RDMA controller 13c extracts the latest M access counts from the memory extended region 31 and calculates the average value A of the M access counts.

Then, the RDMA controller 13c determines that the access count is small in cases where the calculated average value A is below the threshold E (for convenience, referred to as the “threshold E2”). The threshold E (threshold E1) used in the first logic and the threshold E (threshold E2) used in the second logic may be the same value, or may be different values.

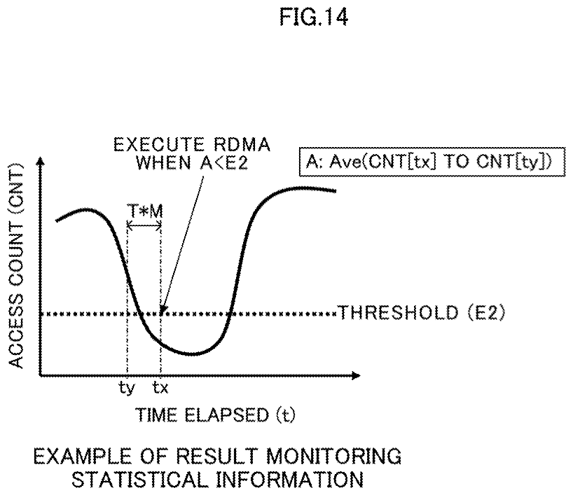

FIG. 14 is a diagram illustrating an example of the result of monitoring the statistical information. As illustrated in FIG. 14, the RDMA controller 13c makes threshold determination at predetermined regular time intervals T along the second logic.

For example, at the time tx, the RDMA controller 13c determines that the average value A of the latest M access counts in the T×M period (ty to tx) is below the threshold E2. On the basis of this determination, the RDMA controller 13c reads the transfer request from the queue 13d and notifies the RDMA executor 15a of the content of the transfer request.

Thus, the RDMA controller 13c may determine that, through detecting that the average value A is below the threshold E2, the access count is small, in other words, may determine that the timing of executing the RDMA transfer comes.

That is, the condition for suppressing the access congestion is satisfied when the average access count A of M access counts obtained by the RDMA controller 13c at regular time intervals T is below the threshold.

As described above, the RDMA controller 13c may detect that the access count is small when the above condition (a) or (b) is satisfied, or, may detect that the access count is small when the above conditions (a) and (b) are both satisfied.

### [1-4] Example of Operation

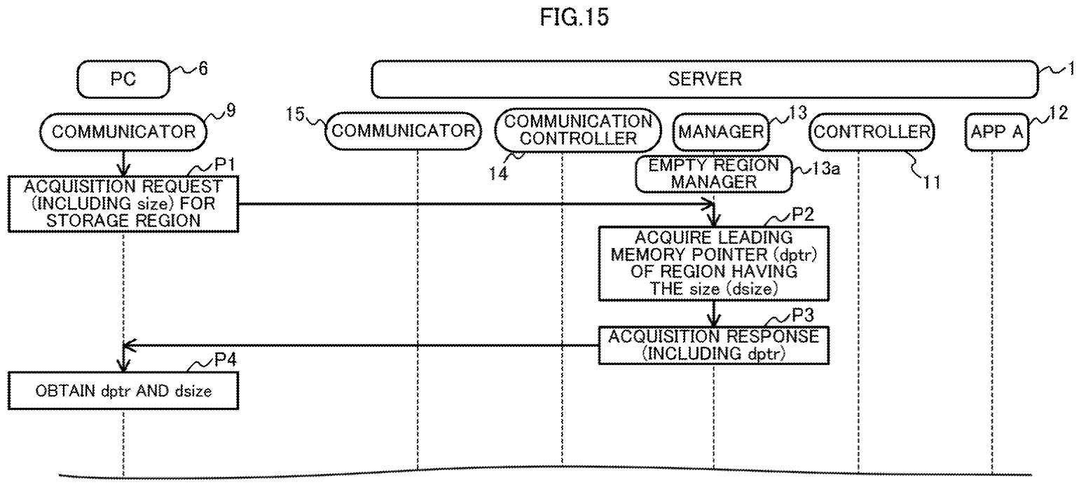

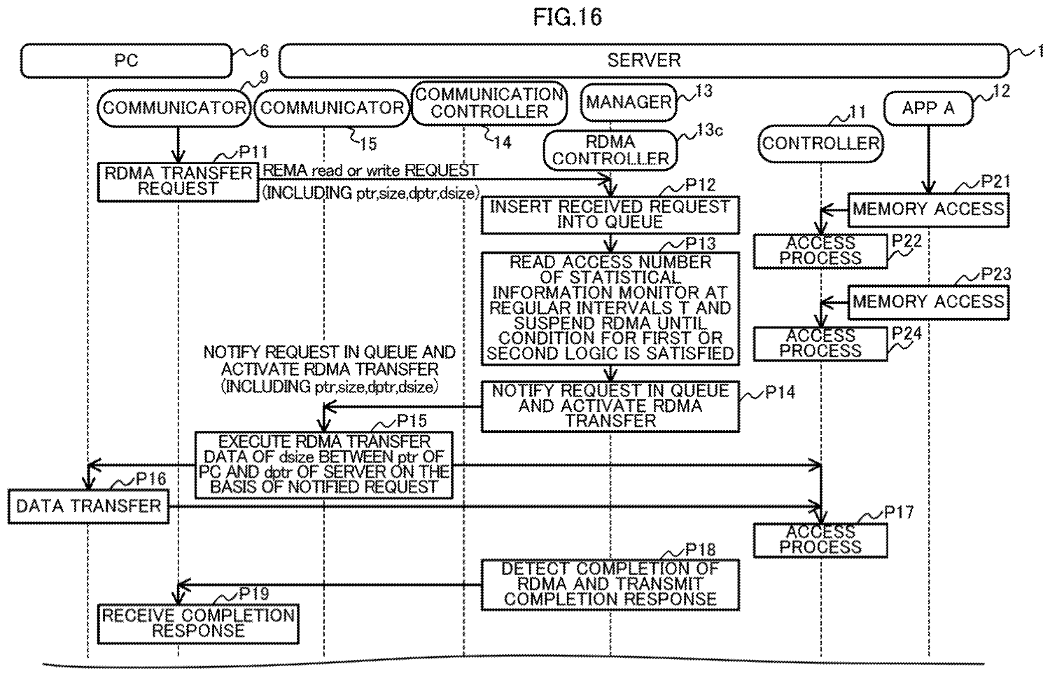

Next, with reference to FIGS. 15 and 16, description will now be made in relation to an example of operation of a system including the server 1 and the PC 6 according to one embodiment having the configuration described above.

### [1-4-1] Example of Operation of Acquisition Process of Region in Storage Region

First, referring to FIG. 15, description will now be made in relation to an example of operation of an acquisition process of the region 41a in the storage region 41 by the server 1 and the PC 6.

As illustrated in FIG. 15, when the PC 6 determines to execute the RDMA transfer, the allocation requester 91 of the communicator 9 transmits an acquisition request for the storage region 41 as much as a data size (size) to be transferred through the RDMA transfer to the server 1 (Process P1).

In the server 1, the manager 13 receives the acquisition request through the communicator 15 and the communication controller 14. The empty region manager 13a of the manager 13 acquires the leading memory pointer (dptr) in the empty region 41a having a size (dsize) from the storage region 41 by using, for example, the function of the OS (Process P2).

The empty region manager 13a transmits an acquisition response including at least the acquired leading memory pointer to the communicator 9 of the PC 6 via the communication controller 14 and the communicator 15 (Process P3). The acquisition response may include the size (dsize) of the acquired region 41a.

The allocation requester 91 of the communicator 9 receives the acquisition response, acquires the leading memory pointer (dptr) and the size (dsize) (Process P4), and then the process ends. Incidentally, in cases where the size (dsize) is not included in the acquisition response, the allocation requester 91 may regard the size (size) transmitted in the form of being included in the acquisition request as the dsize.

The allocation requester 91 may notify the transfer requester 92 of the acquired dptr and dsize.

### [1-4-2] Example of Operation of Control Related to RDMA Transfer

Next, description will now be made in relation to an example of an operation of the control related to the RDMA transfer by the server 1 and the PC 6 with reference to FIG. 16.

As illustrated in FIG. 16, in the PC 6, when the region 41a in the storage region 41 is acquired by the allocation requester 91 of the communicator 9, the transfer requester 92 transmits an RDMA transfer request to the server 1 (Process P11). The RDMA transfer request may be, for example, an RDMA read request or an RDMA write request, and may contain information of ptr, size, dptr, and dsize. The RDMA transfer request may also include NW_Addr of the communicator 9.

In the server 1, the manager 13 receives the RDMA transfer request through the communicator 15 and the communication controller 14. The RDMA controller 13c of the manager 13 inserts the received RDMA transfer request into the queue 13d (Process P12).

The RDMA controller 13c reads access counts of the statistical information monitor 13e at regular time intervals T, and stores M access counts into the memory extended region 31. Then, the RDMA controller 13c suspends the RDMA transfer request stored in the queue 13d until one or both of the first logic and the second logic described above are satisfied on the basis of the M access counts (Process P13).

In the example of FIG. 16, in parallel with Process P13, a memory access is made from the APP A (Processes P21 and P23), and the controller 11 executes an access process to the DRAM 3 or the PM 4 in response to the memory access request from the APP A (Processes P22 and P24).

When the access process in Processes P22 and P24 or the like is completed and one or both of the first logic and the second logic are satisfied, in other words, when the memory access count of the memory access made by the controller 11 is small is detected, the process proceeds to P14.

In Process P14, the RDMA controller 13c starts an RDMA transfer process by reading the leading RDMA transfer request from the queue 13d and notifying the communicator 15 of the contents of the read RDMA transfer request via the communication controller 14.

When being notified of the contents of the RDMA transfer request, the RDMA executor 15a of the communicator 15 executes the RDMA transfer process of data having a size (dsize) between the ptr of the PM 4 and the dptr of the server 1 on the basis of the contents of the request (Process P15).

In the RDMA transfer process, for example, data transfer (Process P16) from (or to) the region 8a in the DRAM 8 of the PC 6 may be performed. The operation subject of the RDMA transfer process may be the RDMA executor 15a of the communicator 15, but may alternatively be the communicator 9 of the PC 6 (e.g., RDMA controller) or the both communicators 15 and 9.

The controller 11 performs the access process to the region 41a in the storage region 41 on the basis of the memory access caused in the RDMA transfer process (Process P17).

Upon detecting the completion of the RDMA transfer process, the RDMA controller 13c transmits a completion response to the transfer requester 92 in response to the RDMA transfer request (Process P18).

The transfer requester 92 receives the completion response from the RDMA controller 13c (Process P19), and the process ends.

In cases where multiple RDMA transfer requests are stored in the queue 13d, the RDMA controller 13c may repeat Process P13 to Process P18 after Process P18 until no RDMA transfer request is left in the queue 13d.

### [2] Miscellaneous

The technique according to one embodiment described above can be changed or modified as follows.

For example, in the server 1 illustrated in FIG. 7, the functions of the empty region manager 13a and the RDMA controller 13c of the manager 13 may be merged or each divided. Further, in the PC 6 illustrated in FIG. 7, the functions of the allocation requester 91 and the transfer requester 92 of the communicator 15 may be merged, or each may be each divided.

In one aspect, it is possible to suppress lowering of the processing performance of an information processing apparatus including a processor having a memory region and a memory controller that controls an access to the storage region.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a memory region;
a communication interface that is connected to an access apparatus different from the information processing apparatus;
a storage region that the communication interface accesses in response to an access request from the access apparatus; and
a processor coupled to the memory region and the storage region, and configured to access the memory region and the storage region, wherein
the processor comprising a memory controller configured to control an access to the memory region and an access to the storage region, and
the processor is configured to control, based on a state of one or more first accesses to the memory region and the storage region via the memory controller, a timing of executing a second access to the storage region that the communication interface makes via the memory controller.

2. The information processing apparatus according to claim 1, wherein
when the state of the one or more first accesses satisfies a condition for suppressing access congestion in the memory controller, the access congestion being caused by execution of the one or more first accesses and the second access, the processor causes the communication interface to execute the second access.

3. The information processing apparatus according to claim 2, wherein:
the processor comprising a queue that stores the access request from the access apparatus; and
when the state of the one or more first accesses satisfies the condition, the processor notifies the communication interface of the access request stored in the queue.

4. The information processing apparatus according to claim 2, wherein
upon receipt of an acquisition request for the storage region from the access apparatus, the processor reserves a storing region having a size assigned by the acquisition request in the storage region, and transmits an acquisition response including information that specifies a position of the reserved storing region to the access apparatus.

5. The information processing apparatus according to claim 4, wherein the access request is transmitted from the access apparatus after the processor transmits the acquisition response, and includes the information that specifies the position of the reserved storing region and the size of the reserved storing region.

6. The information processing apparatus according to claim 2, wherein,
the condition is satisfied when, among M access counts (where M is an integer of two or more) of the one or more first accesses that the processor obtains at regular time intervals, L or more access counts (where L is an integer of two or more and M or less) are below a threshold.

7. The information processing apparatus according to claim 2, wherein
the condition is satisfied when M access counts (where M is an integer of two or more) of the one or more first accesses that the processor obtains at regular time intervals are all below a threshold.

8. The information processing apparatus according to claim 2, wherein
the condition is satisfied when an average access count of M access counts (where M is an integer of two or more) of the one or more first accesses that the processor obtains at regular time intervals is below a threshold.

9. The information processing apparatus according to claim 1, wherein
in a case where the processor detects completion of the second access made by the communication interface, the processor transmits a completion response of the access request to the access apparatus via the communication interface.

10. The information processing apparatus according to claim 1, wherein the access request is a Remote Direct Memory Access (RDMA) transfer request.

11. A non-transitory computer-readable recording medium having stored therein an information processing program causing a computer to execute a process comprising:
accessing a memory region and a storage region via a memory controller that controls access to the memory region and the storage region, the storage region being accessed by a communication interface connected to an access apparatus different from the computer accesses in response to an access request from the access apparatus; and
controlling, based on a state of one or more first accesses to the memory region and the storage region via the memory controller, a timing of executing a second access to the storage region that the communication interface makes via the memory controller.

12. The non-transitory computer-readable recording medium according to claim 11, the process further comprising
when the state of the one or more first accesses satisfies a condition for suppressing access congestion in the memory controller, the access congestion being caused by execution of the one or more first accesses and the second access,
causing the communication interface to execute the second access.

13. The non-transitory computer-readable recording medium according to claim 12, the process further comprising
when the state of the one or more first accesses satisfies the condition,
notifying the communication interface of the access request from the access apparatus, the access request being stored in a queue that stores the access request.

14. The non-transitory computer-readable recording medium according to claim 12, the process further comprising
upon receipt of an acquisition request for the storage region from the access apparatus,
reserving a storing region having a size assigned by the acquisition request in the storage region; and
transmitting an acquisition response including information that specifies a position of the reserved storing region to the access apparatus.

15. The non-transitory computer-readable recording medium according to claim 14, wherein
the access request is transmitted from the access apparatus after the acquisition response is transmitted, and includes the information that specifies the position of the reserved storing region and the size of the reserved storing region.

16. The non-transitory computer-readable recording medium according to claim 12, wherein,
the condition is satisfied when, among M access counts (where M is an integer of two or more) of the one or more first accesses that the computer obtains at regular time intervals, L or more access counts (where L is an integer of two or more and M or less) are below a threshold.

17. The non-transitory computer-readable recording medium according to claim 12, wherein
the condition is satisfied when M access counts (where M is an integer of two or more) of the one or more first accesses that the computer obtains at regular time intervals are all below a threshold.

18. The non-transitory computer-readable recording medium according to claim 12, wherein
the condition is satisfied when an average access count of M access counts (where M is an integer of two or more) of the one or more first accesses that the computer obtains at regular time intervals is below a threshold.

19. The non-transitory computer-readable recording medium according to claim 11, the process further comprising
in a case where completion of the second access made by the communication interface is detected,
transmitting a completion response of the access request to the access apparatus via the communication interface.

20. The non-transitory computer-readable recording medium according to claim 11, wherein the access request is a Remote Direct Memory Access (RDMA) transfer request.
